(19) United States
(12) Patent Application Publication
(10) Pub. No.: US 2012/0032380 A1
(43) Pub. Date: Feb. 9, 2012

(54) PCB holder

(75) Inventor: Valeri Riachentsev, Houston, TX (US)

(73) Assignee: Valeri Riachentsev, Houston, TX (US)

(21) Appl. No.: 12/806,219

(22) Filed: Aug. 9, 2010

(51) Int. Cl. B25B 11/00

(52) U.S. Cl. 269/8

(57) ABSTRACT

Design and method of Printed Circuit Board (PCB) clamping at the edge by using the friction between clamp and PCB edge is disclosed. Method provides non-screw PCB engaging and disengaging. Applicable for the manual and machine PCB service.

### BACKGROUND OF THE DISCLOSURE

1. Field of Invention

The present invention relates to the field of the PCB holding devices during the PCB service by operator and machine.

2. Description of the Related Arts

Well known and widely used the variety of the PCB holders providing the PCB support with the various clamps attached to the PCB. For instance, alligator-type-clamp or groove-type-clamp attached to the PCB require significant amount of PCB surface along the edge to be occupied by the known clamps.

Other solutions are using a vacuum clamp for PCB holding—see U.S. Pat. No. 6,635,308.

The vise-type PCB holders are capable to hold PCB at the sides, but have rather long screw-driving vises attached to the PCB sides that makes difficult to service the parts soldered close to the edge. Also, vise-type holders require PCB to be tightened by screw each time when PCB goes out/in of the holder.

### SUMMARY OF THE DISCLOSURE

The present invention is offering the solution where: 1) clamp does not occupy the PCB soldering surface; 2) PCB is holding by friction at PCB edge and at least one of next elements has to be a spring-type: holding rod-clamp, rod pad, and/or base plate; 3) holding PCB force is applied perpendicular to the PCB edge, but not to the top/bottom of PCB as in prototypes; 4) all holder parts attached to the PCB can be dielectric for PCB safe service; 5) PCB clamp design does not require the screw-type or similar devices for PCB engaging and release; 6) holder is capable to withstand a large vertical force applied to PCB; 7) offered PCB HOLDER is relatively simple in design and has all above advantages.

### BRIEF DESCRIPTION OF THE DRAWINGS

FIG. 1 shows a PCB holder general view.

FIG. 2 shows a non-spring rod-clamp when PCB is not engaged.

FIG. 3 shows a non-spring rod-clamp when PCB is engaged.

FIG. 4 shows a spring rod-clamp.

FIG. 5 shows a spring rod-clamp when side force is applied.

FIG. 6 shows a holder having a rigid rod-clamp 3 fixed to the base 1 and sliding flexible rod-clamp 18 with attached permanent magnet 5.

FIG. 7 shows a wire-spring-type clamp with a shoulder.

FIG. 8, FIG. 9 and FIG. 10 show the sequence of PCB engagement with a fixed rigid-rod-clamp 2 and a sliding-spring-rod-clamp 3 with magnet 5.

FIG. 11, FIG. 12 and FIG. 13 show the sequence of PCB engagement with all fixed spring-rod-clamps.

FIG. 14 and FIG. 15 show the sequence of PCB engagement with all sliding rigid-rod-clamps 5 attached to the spring base 1 by magnets 5.

### DETAILED DESCRIPTION OF THE DISCLOSURE

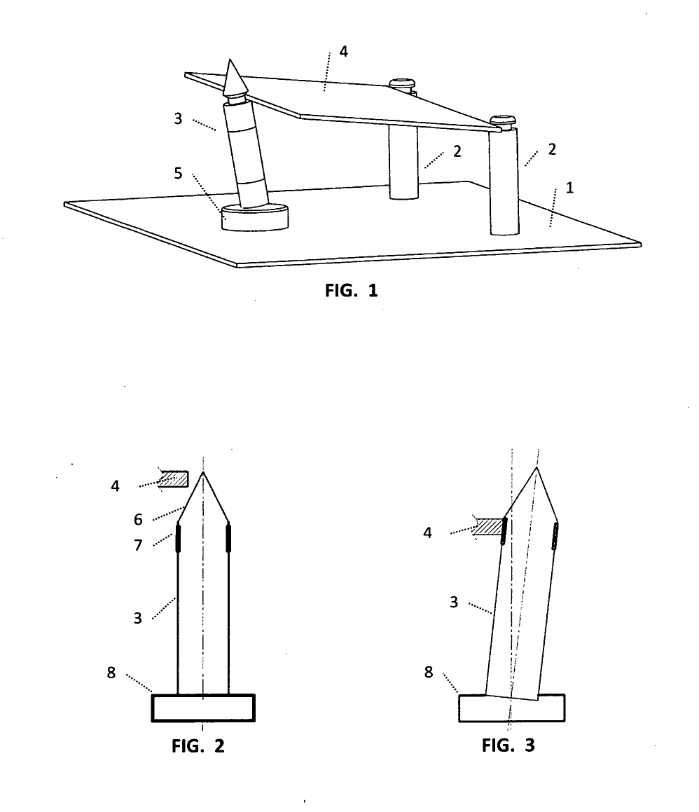

FIG. 1 shows the PCB holder general assembly which includes: base 1 with attached rod-clamps 2 and 3. Clamps 2 are rigid and permanently attached to the PCB by screws or welding. Clamp 3 is spring-type in radial direction and is capable to slide along the base 1 with a friction and said rod is attached to the ferromagnetic base 1 by a permanent magnet 5.

Force and friction between the magnet 5 and base 1 must be strong enough to keep the PCB 4 fixed in place for a service, and weak enough to let the operator to slide the magnet 5 along the base 1. Such friction magnet sliding is required for the rods adjustment to the specific PCB dimensions and shape.

PCB HOLDING ROD. FIG. 2 shows the rod 3 having low-friction-sliding area 6 and high-friction-clamping area 7. Low-friction area 6 provides easy PCB insertion into the clamping area 7. High friction clamping area 7 keeps PCB 4 in place during the PCB service—see FIG. 3.

Initially, PCB sits in position as on FIG. 2. Then PCB slides down along the rod-clamp 3 and inclines the rod as on FIG. 3. PCB easy slides down along low friction surface 12, which made, for instance, of nylon or polished steel. Continue sliding down, PCB reaches high friction clamping area 7—see FIG. 3. Clamping area is made, for instance, by applying: high friction coating, thread, notches, grooves or/and rubber insert.

FIG. 1 shows two rigid clamps and one spring one. Three clamps is a minimum number for PCB fixity. Any combination of the rigid clamps and spring clamps is allowable depending on specific PCB design and soldering technology. Nevertheless, when all clumps are rigid then base 1 has to be spring-type as on FIG. 15.

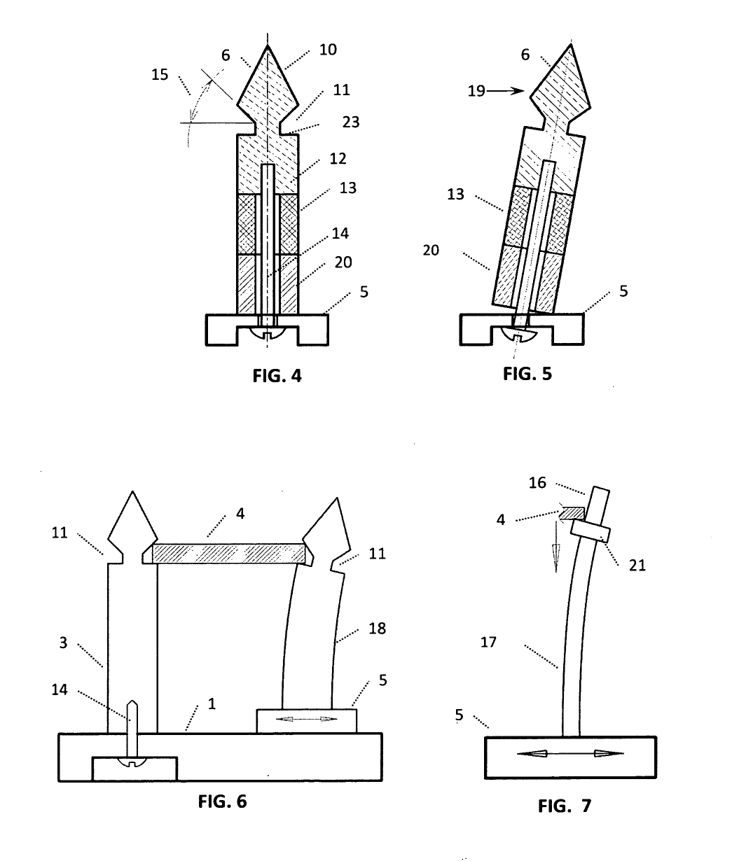

FIGS. 4 and 5 show the PCB clamping area made as a groove. Angle 15 on FIG. 4 has to be sharp enough to keep PCB in place and to provide auto-clamping of PCBs having various thickness. PCB pullout (disengagement) force can be adjusted by varying the angle opening 15 as well. The larger angle the lower force. Lower supporting shoulder 23 of the groove 11 can be either flat horizontal or have some angle up and down from to meet specific PCB requirements.

PCB also can be unclamped by force 19 (see FIG. 5) which can be applied to incline the spring clamp(s) manually or by machine.

PCB holding groove can be filled with soft or/and adhesive material, such as a rubber, elastomer and etc. for stronger PCB clamping force.

FIG. 7 shows spring-rod holder 17 made either of spring wire or a spring strip and comprising a shoulder 21 for PCB 4 support.

ATTACHING RODS TO BASE. PCB rod-clamp 3 (see FIG. 6) can be attached to the base 1 either permanently, for instance by the screw 14 or welding, or with a friction by the magnetic pad 5. Rod can be attached to the ferromagnetic base directly if made magnetic as well.

SPRING ELEMENTS OF THE HOLDER. PCB can be loaded into the PCB HOLDER only if at least rod or/and base made as a spring(s). Spring rod-clamp has to be flexible in the radial direction and rigid in the axial direction. Rod can be circular, rectangular and flat in section. Base 1, see FIG. 15, also can be fabricated as a spring. Rod assembly may include external springs as, for instance pad 8 as on FIG. 2 and FIG. 3, which in this case considered as a part of the rod assembly. Simultaneously applying the spring-base and the spring-rods in the same holder is acceptable.

### Example 1

Spring rod 18 on FIG. 6 is flexible and made of rubber or elastomer. Rod 3 is rigid.

### Example 2

Spring rod on FIG. 4 contains several details. Detail 12 made of nylon and attached to the pad 5 by the screw 14. Standoff 20 is made of plastic or metal and capable to slide along the screw 14. Spring 13 made of rubber or steel. Operation of such spring rod is: when force 19 (see FIG. 5) is applied to the cone 6, then pad 5 and standoff 20 compress the spring 13 developing the PCB holding force directed opposite to the force 19 and holding the PCB (PCB is not shown).

### Example 3

Wire-spring rod 17 on FIG. 7 shows the wire-spring clamp 17 with the PCB holding shoulder 21 attached to the wire. Flat spring can be used instead of circular wire.

### Example 4

Spring pad on FIG. 3 shows a rod 3 with attached spring pad 8 made of spring material such as a steel, rubber, magnetic rubber etc. Pad 8 can be attached to the base permanently, for instance by screw, glue, welding etc., or with a sliding, if the pad is made of magnetic rubber.

### Example 5

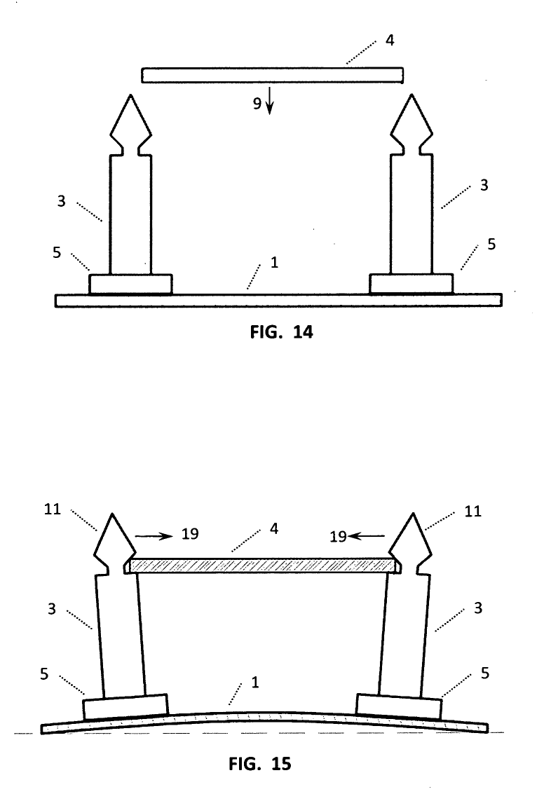

FIG. 14 and FIG. 15 show as PCB 4 is clamping by the rigid rod-clamps and the spring-base 1 made of spring steel, plastic or elastomer. Spring base 1 bend develops the clamping force 19. Pads 5 in this example is shown as sliding magnetic pads attached to ferromagnetic base 1, but may be permanently attached as well.

PCB INSERTION INTO HOLDER. There are two examples described for PCB insertion. 2 rods are shown only for clear picture.

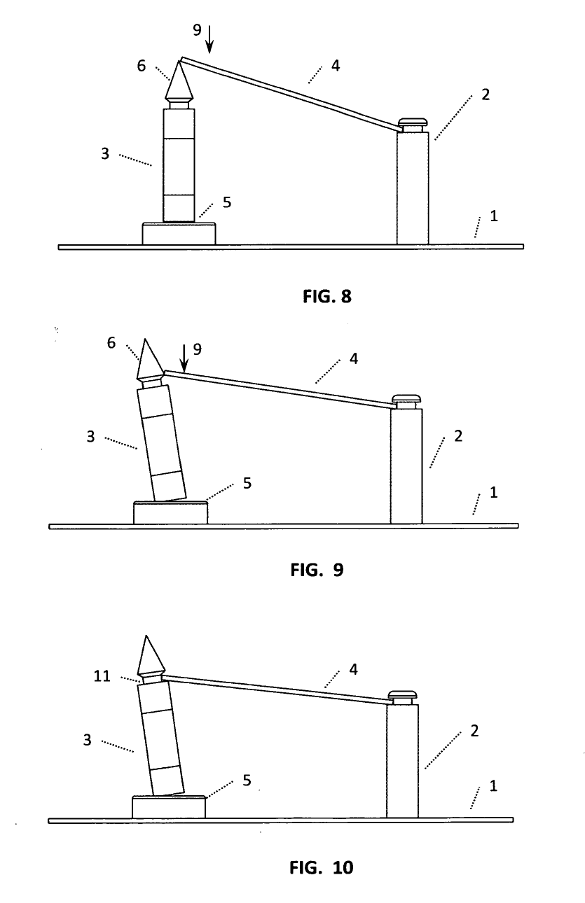

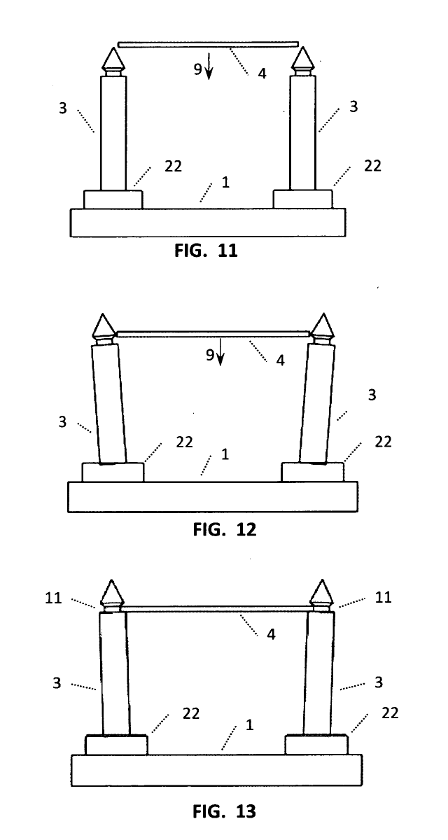

FIG. 8, FIG. 9 and FIG. 10 show angle-to-base PCB-insertion. Rod 2 is rigid and fixed to the base 1 and the rod 3 is a spring-type and capable to slide along the base 1. FIG. 8 shows initial PCB position, when lower right end of PCB 4 is inserted into clamp 2. FIG. 9 shows when PCB edge is sliding along the cone edge 6 of the spring clamp 3. FIG. 10 shows when PCB 4 is latched by clamp 11. Rod 3 on FIG. 11 has inclination needed to provide a force hold PCB 4 in groove 11.

FIG. 11, FIG. 12 and FIG. 13 show parallel-to-base PCB insertion. All shown rods are spring-type, attached to the base 1 by magnetic rubber pads 22 working as a spring pads and attaching the rods 3 to the base 1 by magnetic force. Rod(s) 3 is capable to slide along the base 1. FIG. 11 shows initial PCB position. FIG. 12 shows when PCB sliding along the rod(s) 3 with force 9 and inclines the rod(s) 3. FIG. 12 shows when PCB is latched in 11.

At least one of above spring details, rod, pad and base, has to operate as a loaded spring providing the force acting either perpendicular or at the angle to the PCB edge. For example, FIG. 13 shows the force acting perpendicular to the PCB edge and FIG. 10 shows the angle-acting force to the PCB edge.

What I claim is:

1. A design of Printed Circuit Board (PCB) holder having a base and comprising at least two screw-type holding PCB clamps at the top and bottom of PCB face, wherein improvement comprises: at least three rod-clamps which are mechanically or/and magnetically attached to the base, and where at least one of the rods or/and the base are made as a spring, and said rod(s) holds PCB at the edge by the friction between the rod and PCB.

2. A PCB holder according to the claim 1 wherein: the rod-clamp is fabricated as a spring which is flexible in radial direction and rigid in axial direction.

3. A PCB holder according to the claim 1 wherein: rod-clamp comprises a low-friction PCB sliding area on the top and following high-friction PCB holding area.

4. A PCB holder according to the claim 3 wherein: high friction area made as an angle-type groove having the opening greater than PCB thickness.

5. A PCB holder according to the claim 4 wherein: the groove contains a soft insert.

6. A PCB holder according to the claim 1 wherein: the low friction area follows by a shoulder.

7. A PCB holder according to the claim 1 wherein: base and rod-clamp are made magnetically attractive.
